(19) United States
(12) Patent Application Publication
(10) Pub. No.: US 2022/0300910 A1
(43) Pub. Date: Sep. 22, 2022

(54) SYSTEM AND METHOD FOR SCHEDULING A PHOTOGRAPHY SESSION

(71) Applicants: Dimitrios Arhontidis, Prosper, TX (US); Derek Pittsinger, Prosper, TX (US)

(72) Inventors: Dimitrios Arhontidis, Prosper, TX (US); Derek Pittsinger, Prosper, TX (US)

(21) Appl. No.: 17/206,205

(22) Filed: Mar. 19, 2021

(51) Int. Cl. G06Q 10/10; G06Q 10/02; G06Q 20/04

(52) U.S. Cl. CPC G06Q 10/1095; G06Q 10/02; G06Q 20/0457

(57) ABSTRACT

A photography session scheduling system is disclosed, including a photographer device and a client device in operable connection with a network. An application server is in operable communication with the network and configured to host an application system for scheduling a photography session. The application system includes a user interface module for providing access to the application system to the photographer device and the client device. The user interface is in operable communication with: a client database, a photographer database, and a photography session database. A photographer profile interface is configured for displaying a photographer profile including a plurality of photography sessions and a client listing for each of the plurality of photography sessions. A calendar interface permits scheduling of a photography session. A link generation module automatically generates a link corresponding to the photography session and displays the link on a social media page associated with a photographer.

### TECHNICAL FIELD

The embodiments generally relate to computerized systems for scheduling a service and more particularly relate to a computerized system for facilitating the scheduling of photography mini sessions.

### BACKGROUND

In photography, mini sessions are events are created by the photographer for a short period of time, such as for a weekend. The photographer will select a location for the mini session event and indicate if a theme will be supported during the event (e.g., Christmas, Halloween, baby photos, family, portraits, etc.). These sessions are then manually or semi-autonomously booked by the photographer in conjunction with a client relationship management (CRM) system they may use.

In the current arts, many scheduling systems are not tailored for use by photographers and their specific needs during the scheduling and billing processes. While CRM systems are available for many businesses, these systems do not facilitate the various needs of scheduling a photography session, manage photographer availability, provide payment processing services, and otherwise managing the client and photographer experience throughout the process of scheduling the mini session service, receiving payment, and executing the service.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a photography session scheduling system, including a photographer device and a client device in operable connection with a network. An application server is in operable communication with the network and configured to host an application system for scheduling a photography session. The application system includes a user interface module for providing access to the application system to the photographer device and the client device. The user interface is in operable communication with: a client database, a photographer database, and a photography session database. A photographer profile interface is configured for displaying a photographer profile including a plurality of photography sessions and a client listing for each of the plurality of photography sessions. A calendar interface permits scheduling of a photography session. A link generation module automatically generates a link corresponding to the photography session and displays the link on a social media page associated with a photographer, wherein the link is associated with a link page which includes link tabs each associated with photography session and/or photographer information.

The system allows for the photographer to schedule a photography session at a date, time, and location for which clients can schedule an individual photography session. The system allows for forms to be transmitted between the photographer and client, such as client inquiry forms, questionnaires, and contract agreements to ensure a seamless experience and administrative time during the session. Further, the system permits the transmission of payment between the client and photographer, which may aid in reducing canceled sessions. The system also automatically generates a link which can be displayed on the photographer's social media profile and link the user to a link page which contains individual links associated with various information provided by the photographer. For example, each link may be associated with a photography session, the photographer's website, or similar information.

The clients will be able to select a session, sign a contract related to the session, and answer a questionnaire before paying and booking the session. In such, the client and photographer can agree to terms of the contract and session details (e.g., special requests from the client) before payment is rendered to reduce the likelihood of cancelled sessions, contract disagreements, and payment disputes thereafter.

The embodiments provide a method for generating a link associated with a photography session. The photographer first creates a photography session using their photographer profile interface and inputs the various photography session information. The information is then published to permit the scheduling of the photography session via at least one client. A link is generated by a link generation module and is then published on a social media page corresponding to the photographer. The link corresponds to a link page including a selectable link tab(s) each corresponding to the photography session information and/or photographer information. A client inquiry form is transmitted to and completed by the client before being returned to the photographer for acceptance and scheduling of the photography session.

In one aspect, the client questionnaire interface permits the input of a plurality of user-input questions.

In one aspect, the client service contract agreement is customizable via the photographer device.

In one aspect, a session details interface permits the input of a plurality of photography session details, wherein the photography session details are comprised of at least one of the following: a session description, session pricing, and at least one session package.

In one aspect, a client listing interface comprises a listing of a plurality of clients associated with the photographer.

In one aspect, a payment processing module permits the selection of a client payment service, a currency, a sales tax, and a payment timeline.

In one aspect, the photographer profile interface includes a session information portion to display a number of bookings, a number of views, and an amount of earnings each corresponding to a session.

In one aspect, the session information portion includes the session details for the selected session.

In one aspect, the link is configured as a social media plug-in.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the application system, according to some embodiments;

FIG. 3 illustrates a illustrates a screenshot of the photographer profile interface, according to some embodiments;

FIG. 4 illustrates a calendar interface utilized by the photographer to schedule the photography session, according to some embodiments;

FIG. 5 illustrates the photography session details interface, according to some embodiments;

FIG. 6 illustrates a client inquiry form executable via the client device prior to scheduling the photography session, according to some embodiments;

FIG. 7 illustrates an exemplary client service contract agreement transmitted between the photographer and the client, according to some embodiments;

FIG. 8 illustrates an exemplary client questionnaire interface, according to some embodiments;

FIG. 9 illustrates the client listing interface, according to some embodiments;

FIG. 10 illustrates the session link generation interface, according to some embodiments;

FIG. 11 illustrates a link interface, wherein the link has been generated and is selectable via the photographer's device, according to some embodiments;

FIG. 12 illustrates the payment processing interface, according to some embodiments;

FIG. 13 illustrates a block diagram of the server engine and modules, according to some embodiments;

FIG. 14 illustrates a flowchart for a method for scheduling a photography session between a photographer and one or more clients, according to some embodiments;

FIG. 15 illustrates a flowchart for a method of generating a link associated with a photography session, according to some embodiments; and

FIG. 16 illustrates a screenshot of the link page interface associated with the link displayed on the photographer's social media profile, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system and method for providing and scheduling a photography service. The system allows for the photographer to schedule a photography session at a date, time, and location for which clients can schedule an individual photography session. Each photography session may include a theme determined by the photographer or selected by the client. The system allows for forms to be transmitted between the photographer and client, such as client inquiry forms, questionnaires, and contract agreements. Further, the system permits the transmission of payment between the client and photographer.

In some embodiments, the system generates a link which can be displayed on the photographer's social media profile and link the user to a link page which contains individual links associated with various information provided by the photographer. For example, each link may be associated with a photography session, the photographer's website, or similar information.

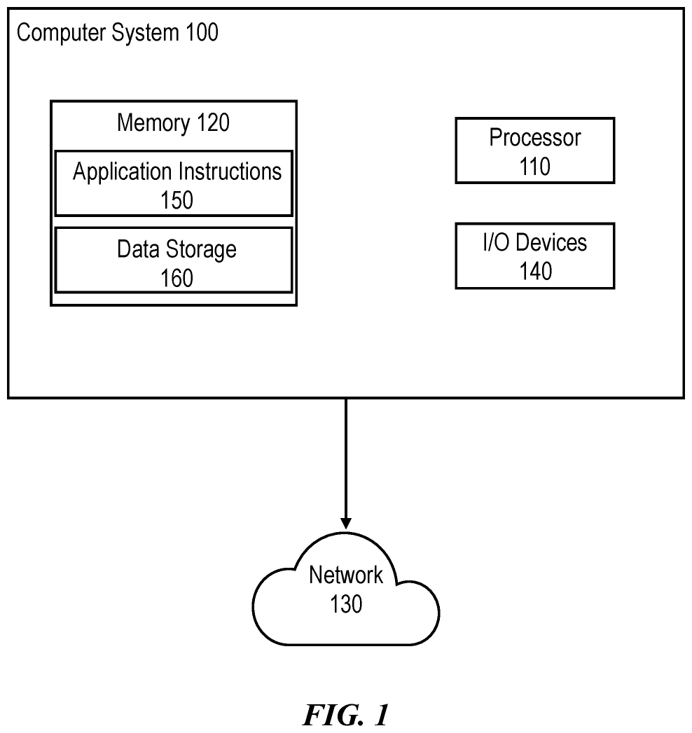

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

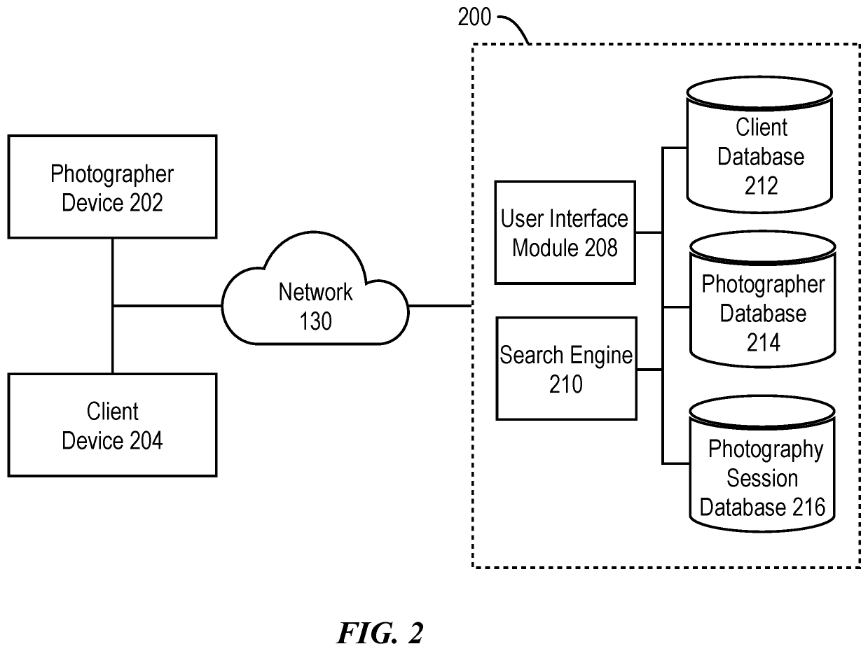

FIG. 2 illustrates a block diagram of the application system 200 in communication with a photographer device 202 and client device 204 via the network 130. The photographer device 202 may be utilized by a photographer to schedule photography sessions, communicate with clients, and otherwise provide services related to the photography session. The client device 204 may be utilized by the client 204 by the client(s) to communicate with the photographer, schedule a photography session, select photography services, submit a payment for the photography services, review works output by the photographer, etc. A user interface module 208 is in communication with the network to display information on the photographer device 202 and client device 204 as described herein. A search engine module 210 is operable to search a client database 212, photographer database 214, and photography session database 216 for information contained within each database. The client database 212 may include client information such as the client's contact information, preferences, historical information related to the client (e.g., previous photography session bookings), and the like. The photographer database 214 may include information such as the photographer's location, preferences, specialties, historical information, a catalog of previous works, and the like. The photography session database 216 stores photography session information such session times, dates, locations, themes, number of clients attending the session, payment information related to the session, etc.

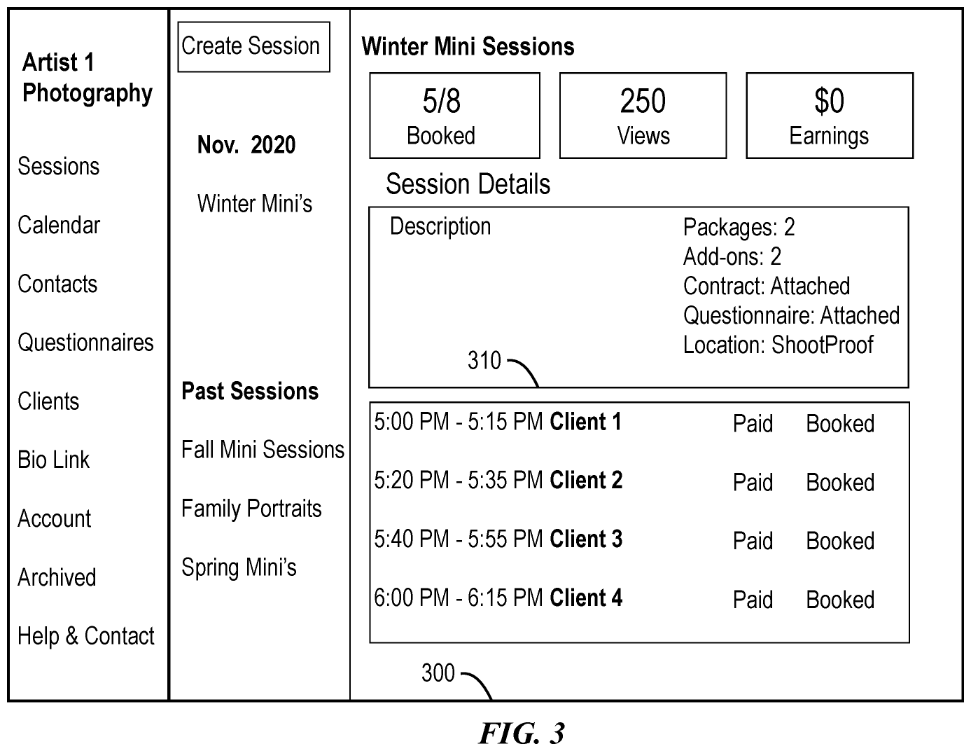

FIG. 3 illustrates a screenshot of the photographer profile interface 300 which includes selectable tabs including a sessions tab, calendar tab, contracts tab, questionnaires tab, clients tab, bio link tab, account tab, archived tab, and a help and contact tab. Each tab may be selected by the photographer to engage with various features of the system. A create sessions icon allows the photographer to create a photography session. Past sessions may be displayed in a listing to allow the photographer to interact with information related to past sessions scheduled using the system. A session information portion 310 displays the number of bookings for the selected session, number of views, earnings, and a listing of clients attending the session. The listing of clients may indicate whether or not the client has paid for their session, time scheduled by each client, and available spaces for the session.

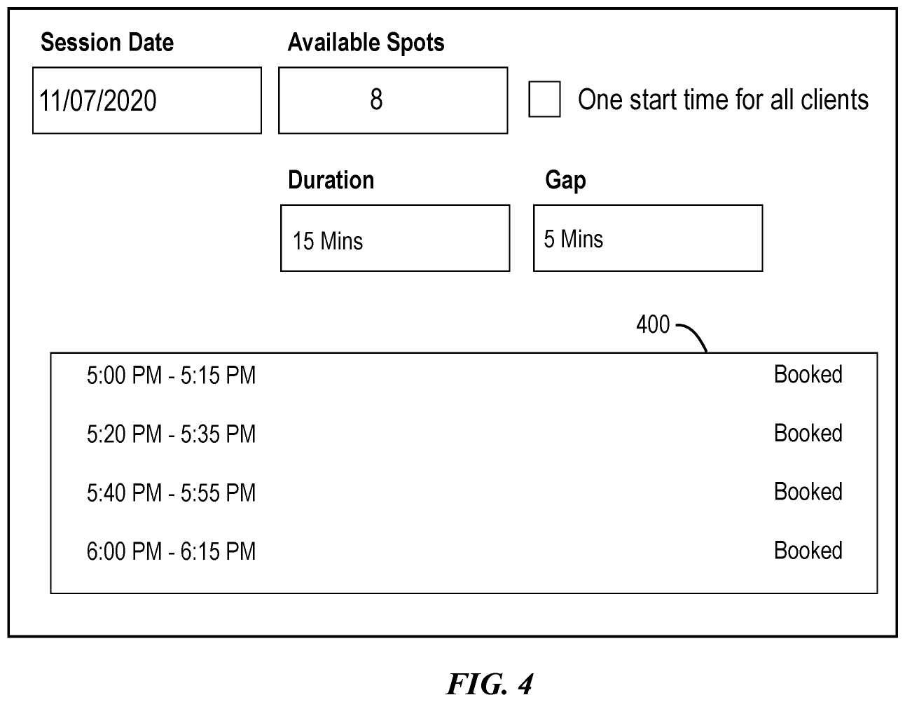

FIG. 4 illustrates a calendar interface 400 wherein the photographer indicates a date(s) and time(s) for which they are scheduling a photography session. The photographer may select the photography session date(s), available spots (i.e., how many individual sessions are available), the duration of each individual session (i.e., spot), and gap time between each individual session. For example, the photographer may permit 8 individual sessions each lasting 15-minutes with a 5-minute gap in between each individual session. Alternatively, the photographer may select to have a single start time for all clients attending the session.

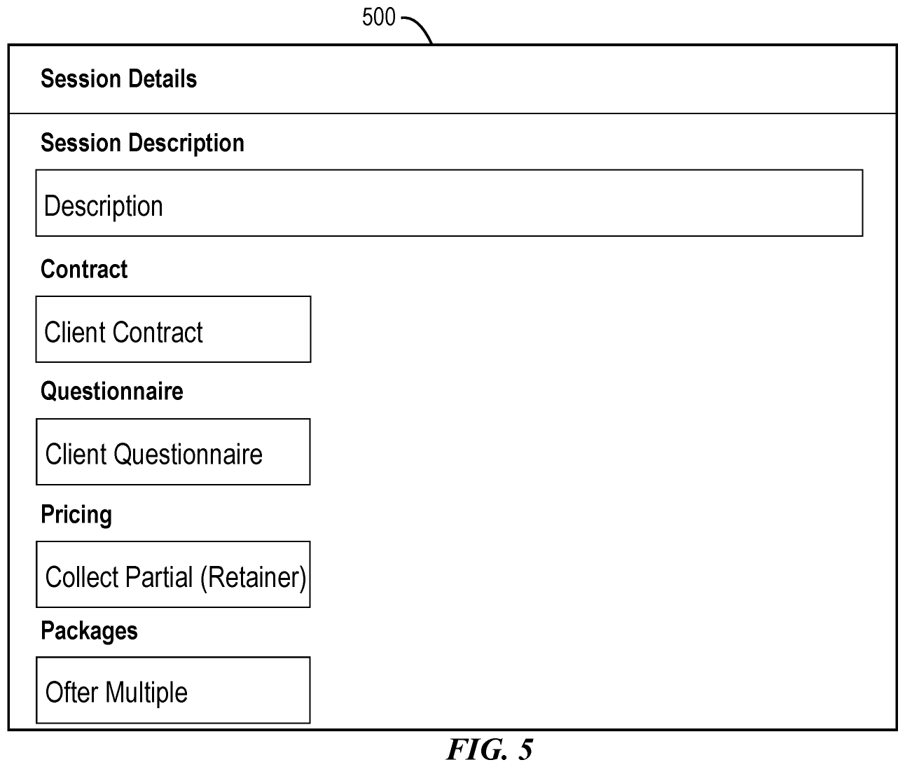

FIG. 5 illustrates the photography session details interface 500 wherein the photographer may include a photography session description. The photography session description can include the theme of the photography session as well as likewise general information. A client contract and client questionnaire may be uploaded to allow the client to execute the client contract, answer questions provided on the client questionnaire, etc. Pricing may be input as well as the pricing scheme for the session. For example, the photographer may select to receive a retainer upon scheduling of the photography session, require payment in-full prior to the scheduling of the photography session, or to require payment at the time of the photography session. Photography packages may be offered to the client, such as for example, offering a pre-set amount and size of photographs.

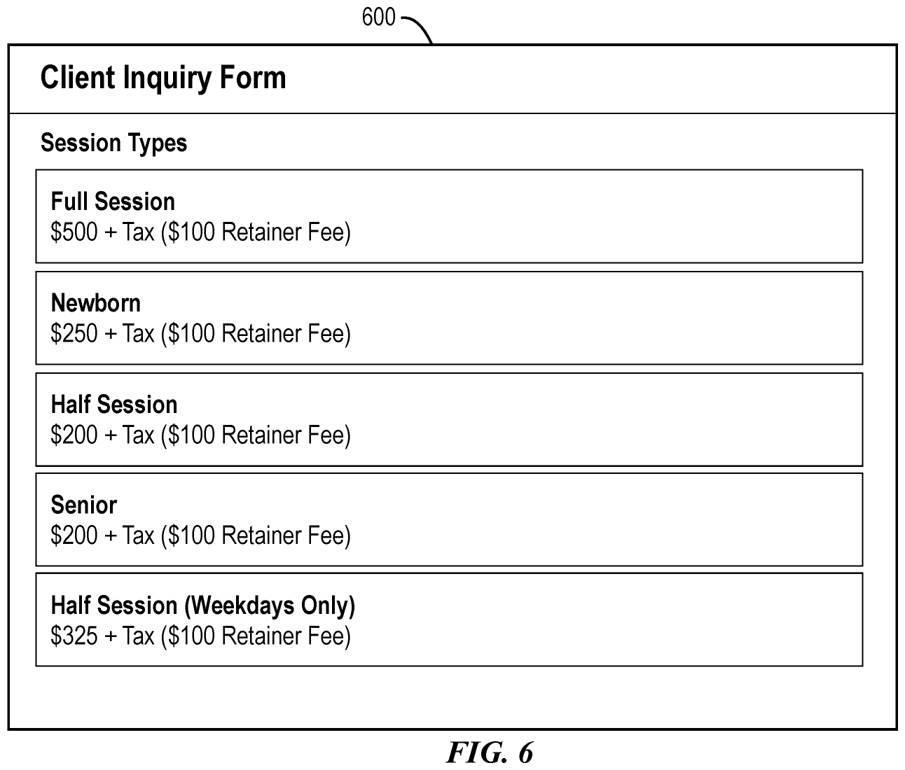

FIG. 6 illustrates a client inquiry form 600 generated by the system which is utilized by the client to submit a client inquiry for one or more of the photographer's available photography sessions. The client inquiry form 600 allows the client to select a session type (e.g., a full session, newborn, half session, senior, weekday session, etc.) which they are interested in. Once completed by the client, the client inquiry form 600 is transmitted to the photographer device via the system to permit the photographer to review the client inquire as well as accept or deny the inquiry. The client inquiry form 600 may be accepted by the photographer before the client can complete their scheduling and rendering payment for the photography session.

In some embodiments, the client inquiry form 600 may be customized by the photographer, such as by adding an image associated with the photography session, including a custom message or description of the session types offered, selecting and uploading supplementary material, etc.

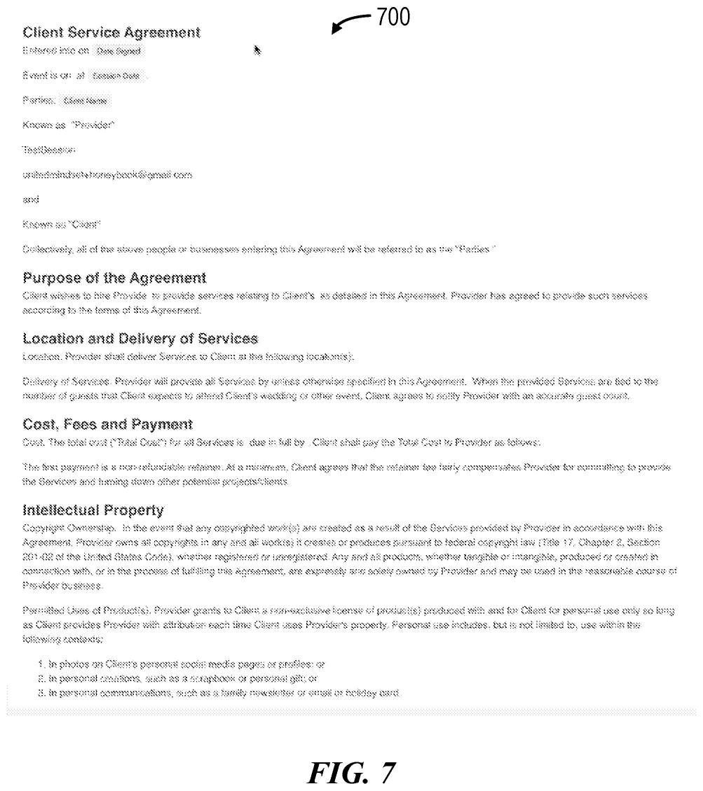

FIG. 7 illustrates an exemplary client service contract agreement 700 which is transmitted between the photographer and the client. The client service contract agreement 700 may be generated and customized by the photographer based on the particular photography session or the client's particular needs.

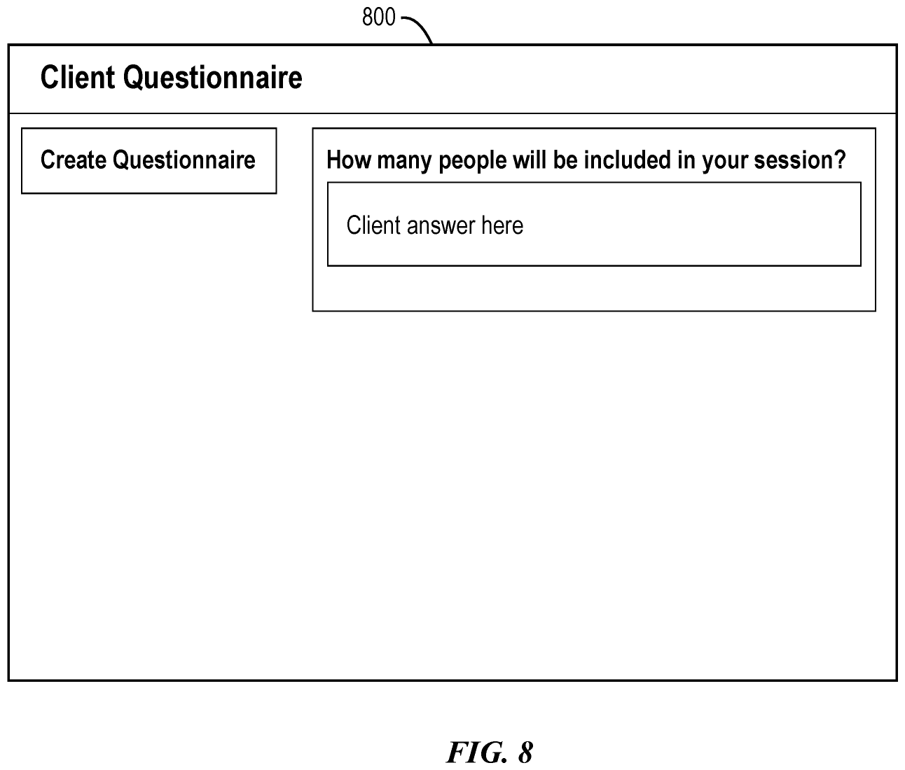

FIG. 8 illustrates an exemplary client questionnaire interface 800 which is transmitted between the photographer and the client. The client questionnaire interface 800 allows the photographer to input various questions which are provided to the client, while allowing the client to respond to each question. For example, the client questionnaire may include a question such as “How many people will be included in your session?”, or “are you bringing any special items (e.g., props) to your photography session?”. In some embodiments, the client questionnaire may be required to be completed before scheduling the photography session to allow the photographer to adjust the session price, duration of the session, etc.

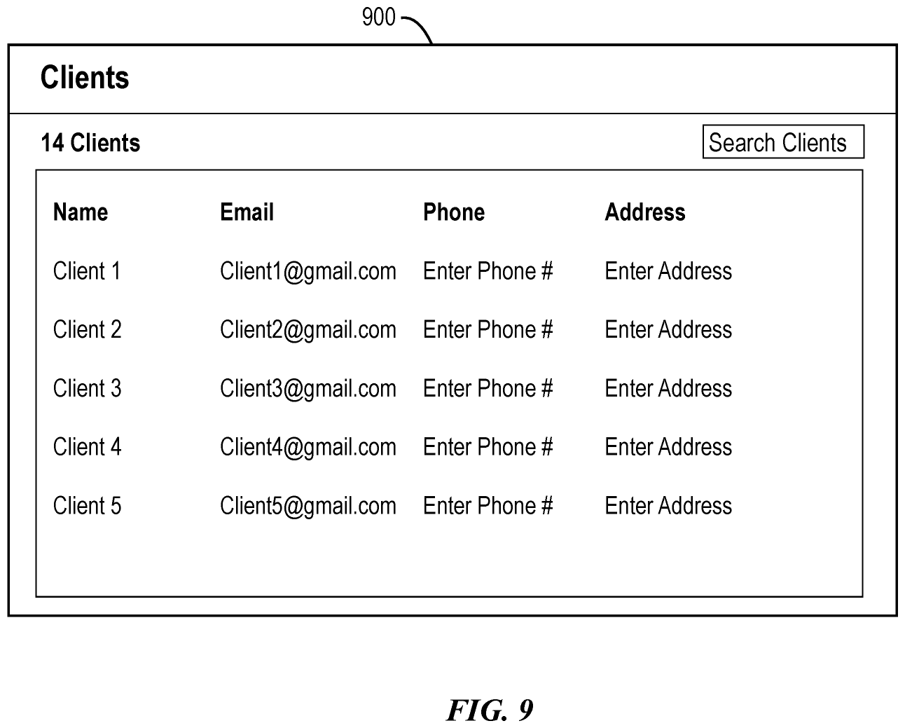

FIG. 9 illustrates the client listing interface 900 which includes a listing of clients which have interacted with the photographer. The client listing may include client contact information stored in the client database. Clients may be separated by various attributes such as location, preferences, or photography session they have scheduled. The search engine module permits the photographer to search for individual clients or groups of clients based on various searchable parameters.

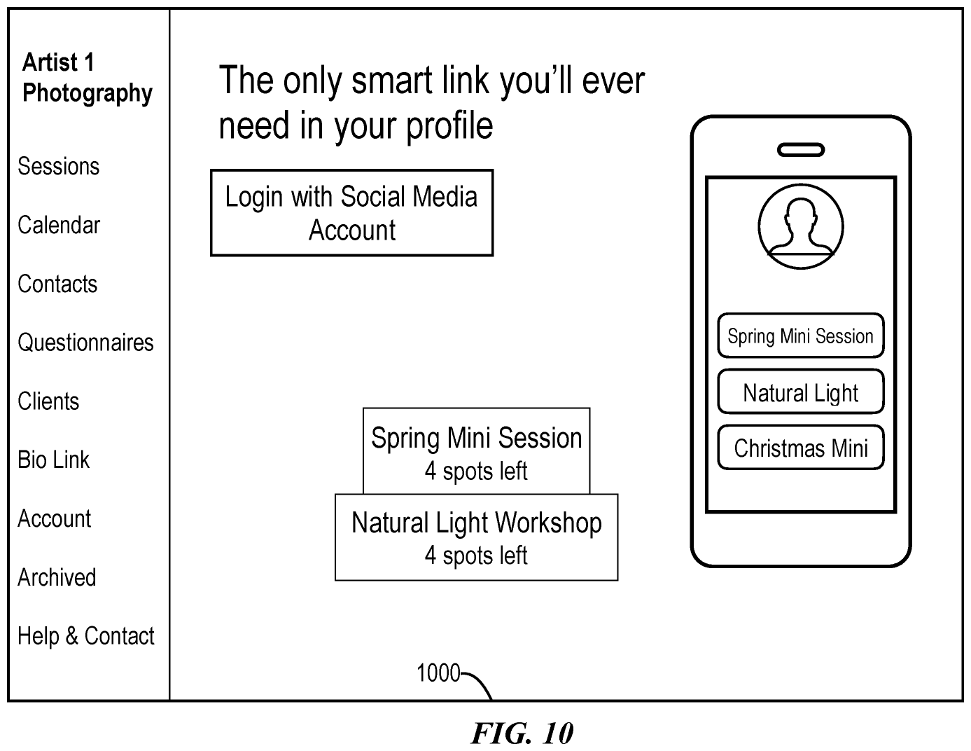

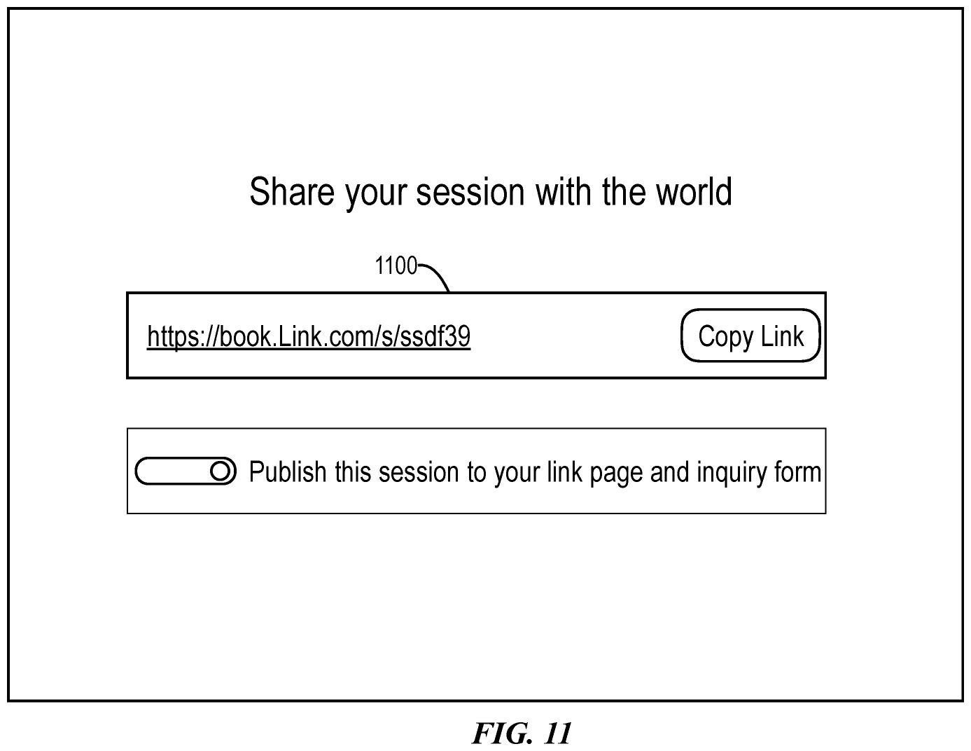

FIG. 10 illustrates the session link generation interface 1000 wherein the photographer can login to a linked social media profile (such as commonly used social media application known in the arts). The photographer can select a photography session for which they would like to generate a link. Once the user selects the photography session, the link 1100 (see FIG. 11) is generated by a link generation module which can be copied and applied to the photographer's social media profile. Further, the link may be published to a link interface which includes a plurality of links previously published by the photographer. The link 1100 may transmit the client (or potential client) to a page containing the client inquiry form, session information page, or other page as predetermined by the photographer.

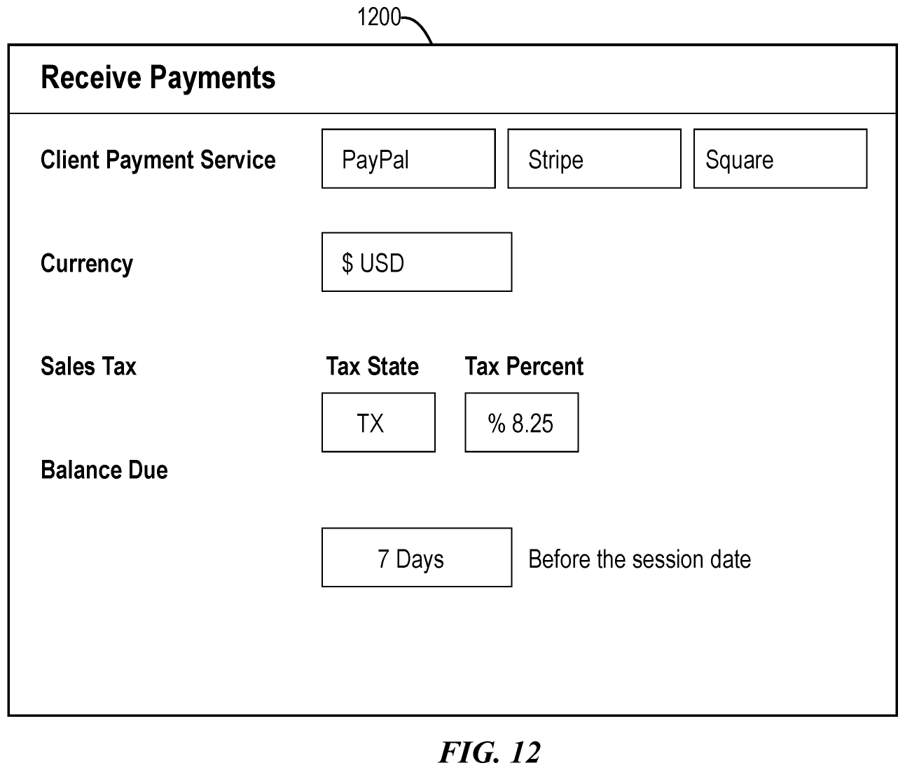

FIG. 12 illustrates the payment processing interface 1200 wherein the photographer selects preferences for receiving payments. For example, the photographer may select the client payment services they will accept, currencies, sales tax options, and payment timelines for each photography session. The payment processing interface 1200 is in communication with a payment processor to permit the transmission of currency from the client to the photographer. Similarly, the payment processor may allow for the payments to be scheduled at predetermined time intervals.

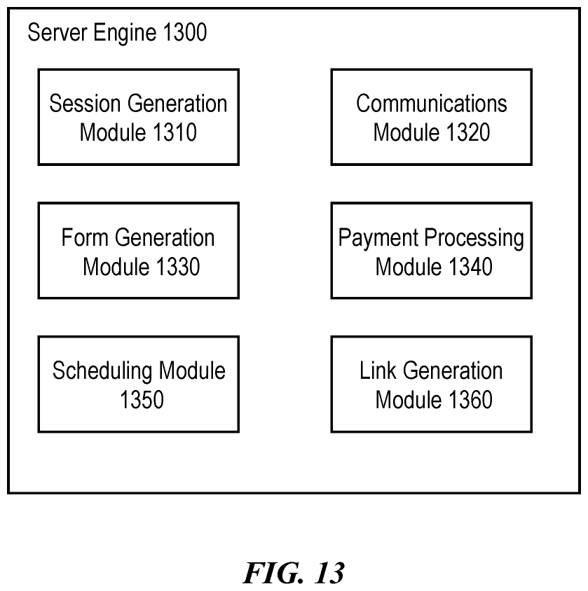

FIG. 13 illustrates a block diagram of the server engine 1300 and modules including the session generation module 1310, communications module 1320, form generation module 1330, payment processing module 1340, scheduling module 1350, and link generation module 1360. The session generation module 1310 permits the photographer to generation a photography session which can be marketed and made available for scheduling. The communications module 1320 permits communications (e.g., via text, audio, email, etc.) between the photographer and the client(s) via the system. Alternatively, the communications module 1320 may facilitate the use of a third-party communications service as known in the arts. The form generation module 1330 may permit the photographer to generate the client contract agreement, client questionnaire, or other supplemental documents which can be transmitted via the communications module 1320 between the photographer and the client. The form generation module 1330 provides a means for generating customizable forms which can be tailored to the clients and/or photographers needs based on the specific photography session to which the form(s) relates. The payment processing module 1340 allows for payments to be transmitted between the client and photographer. The scheduling module 1350 is in operable communication with a calendar system to allow the photographer to schedule a photography session as well as permit the client to schedule individual sessions within the photography session offered by the photographer. The link generation module 1360 generates a link which can be published to the photographer's link page associated with their social media account. The link page may operate as a social media plug-in.

In some embodiments, the communications module 1320 may permit the user to access a notification system which collects responses in a mailbox utility, compose or resend letters, decide on how messages are to be sent, i.e., by email, fax, text, voice, letter, and so forth, and then may assign friends, groups or associates lists as recipients.

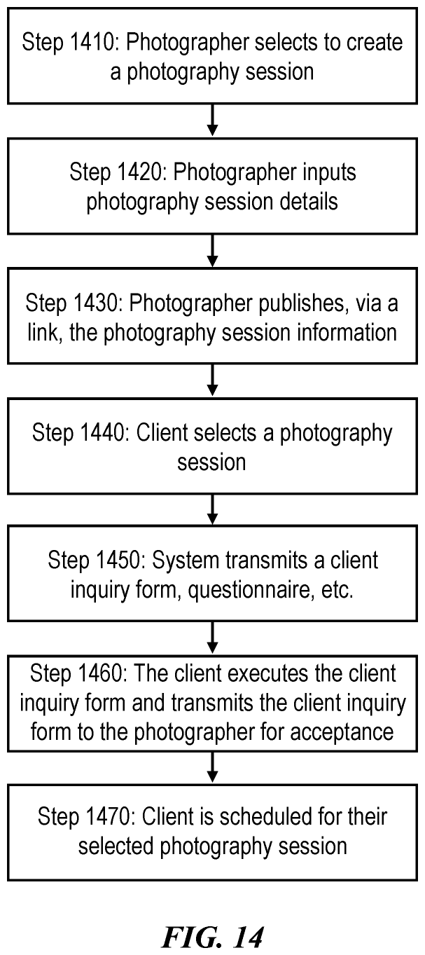

FIG. 14 illustrates a flowchart of a method for scheduling a photography session between a photographer and one or more clients. In step 1410, the photographer selects to create a photography session. In step 1420, the photographer inputs photography session information (e.g., the photography session date, time, number of individual sessions available for the photography session, theme of the photography session, etc.). In step 1430, the photographer publishes the photography session such that clients can inquire and/or schedule an individual session within the photography session. In step 1440, the client selects a photography session and in step 1450, the system transmits a client inquiry form, questionnaire, or other form to the client. Once the form(s) is/are complete and transmitted back to the photographer, the photographer can review the form(s) and accept or deny the client inquiry in step 1460. In step 1470, once the photographer accepts the inquiry, the client is scheduled for their selected individual session of the photography session.

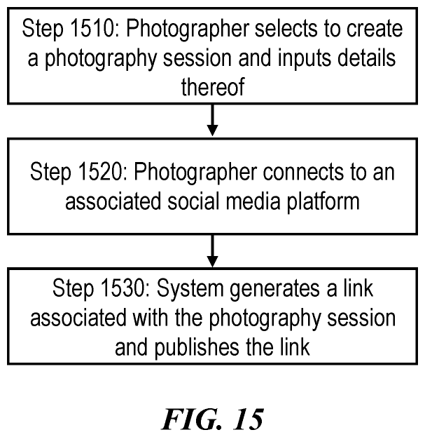

FIG. 15 illustrates a flowchart of a method for generating a link corresponding to a photography session. In step 1510, the photographer selects to create a photography session and inputs details for the photography session. The details may include the photography session date, time, number of individual sessions available for the photography session, theme of the photography session, a general description, etc. which can be displayed to and selected by the client. In step 1520, the photographer connects to their associated social media platform(s) such as by logging into the social media platform(s) via a login interface provided by the system. In step 1530, the system generates a link which is associated with the photography session and the link is displayed on the link page associated with the photographer social media profile and allows the client to select the link to interact with information associated with the photography session.

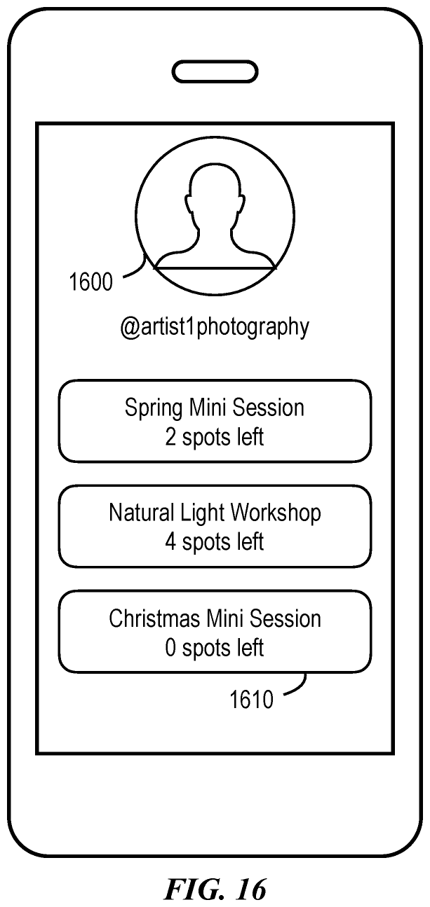

FIG. 16 illustrates a screenshot of the link page interface 1600. Each link tab 1610 is associated with content such as the photographer's webpage, photography session, or other information associated with the photographer or services provided thereby. Each link tab 1610 may include a description of the content associated therewith. Further, the photographer may customize the link tab 1610 with an image. The link page interface 1600 may operate as a social media plug-in for each social media page which the photographer utilizes. The link can then be shared on the user's profile such that clients and potential clients can select the link to be transmitted to the link page interface 1600.

In some embodiments, the link page may be provided as a social media reference landing page such that the link page provides a landing page for each of the photographer's associated links. This allows the photographer to link multiple webpages, informational pages, or landing pages for their photography sessions.

In some embodiments, the links may function as a means for the photographer to advertise their services

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A photography session scheduling system, comprising:
at least one photographer device and at least one client device in operable connection with a network;
an application server in operable communication with the network, the application server configured to host an application system for scheduling a photography session, the application system having a user interface module for providing access to the application system to the at least one photographer device and the at least one client device, the user interface in operable communication with: a client database, a photographer database, and a photography session database, the user interface comprising:
a photographer profile interface configured for displaying a photographer profile including a plurality of photography sessions and a client listing for each of the plurality of photography sessions;
a calendar interface configured for scheduling a photography session via the photographer device; and
a link generation module to automatically generate a link corresponding to the photography session and display the link on a social media page associated with a photographer, wherein the link is associated with a link page including a plurality of link tabs each associated with a plurality of photography session information.

2. The system of claim 1, further comprising a session details interface to permit the input of a plurality of photography session details, wherein the photography session details are comprised of at least one of the following: a session description, session pricing, and at least one session package.

3. The system of claim 1, further comprising a client listing interface comprising a listing of a plurality of clients associated with the photographer.

4. The system of claim 1, further comprising a payment processing module to permit the selection of a client payment service, a currency, a sales tax, and a payment timeline.

5. The system of claim 1, wherein the photographer profile interface includes a session information portion to display a number of bookings, a number of views, and an amount of earnings each corresponding to a session.

6. The system of claim 5, wherein the session information portion includes the session details for the selected session.

7. The system of claim 1, wherein the link is configured as a social media plug-in.

8. A photography session scheduling system, comprising:
at least one photographer device and at least one client device in operable connection with a network;
an application server in operable communication with the network, the application server configured to host an application system for scheduling a photography session, the application system having a user interface module for providing access to the application system to the at least one photographer device and the at least one client device, the user interface in operable communication with: a client database, a photographer database, and a photography session database, the user interface comprising:
a photographer profile interface configured for displaying a photographer profile including a plurality of photography sessions and a client listing for each of the plurality of photography sessions;
a calendar interface configured for scheduling a photography session via the photographer device;
a form generation module operable to generate at least one of the following: a client questionnaire provided on a client questionnaire interface, and a client service contract agreement; and
a link generation module to automatically generate a link corresponding to the photography session and display the link on a social media page associated with a photographer, wherein the link is associated with a link page including a plurality of link tabs each associated with a plurality of photography session information.

9. The system of claim 8, wherein the client questionnaire interface permits the input of a plurality of user-input questions.

10. The system of claim 9, wherein the client service contract agreement is customizable via the photographer device.

11. The system of claim 10, further comprising a session details interface to permit the input of a plurality of photography session details, wherein the photography session details are comprised of at least one of the following: a session description, session pricing, and at least one session package.

12. The system of claim 11, further comprising a client listing interface comprising a listing of a plurality of clients associated with the photographer.

13. The system of claim 12, further comprising a payment processing module to permit the selection of a client payment service, a currency, a sales tax, and a payment timeline.

14. The system of claim 13, wherein the photographer profile interface includes a session information portion to display a number of bookings, a number of views, and an amount of earnings each corresponding to a session.

15. The system of claim 14, wherein the session information portion includes the session details for the selected session.

16. The system of claim 15, wherein the link is configured as a social media plug-in.

17. A method for generating a link associated with a photography session, the method comprising the steps of:
selecting, via a photographer profile interface, to create a photography session;
inputting, a plurality of photography session information;
publishing the photography session information to permit the scheduling of the photography session via at least one client, wherein a link is published on a social media page, wherein the link corresponds to a link page including a selectable link tab corresponding to the photography session;
transmitting a client inquiry form to the at least one client;
accepting the client inquiry form and permitting, via a scheduling module, the scheduling of the photography session.

18. The method of claim 17, further comprising a form generation module operable to generate at least one of the following: a client questionnaire provided on a client questionnaire interface, and a client service contract agreement.

19. The method of claim 18, further comprising a photographer profile interface configured for displaying a photographer profile including a plurality of photography sessions and a client listing for each of the plurality of photography sessions.

20. The method of claim 19, further comprising the step of transmitting the client questionnaire to the client.
